(19) United States
(12) Patent Application Publication
(10) Pub. No.: US 2012/0132370 A1
(43) Pub. Date: May 31, 2012

(54) LABEL PRINTING DEVICE

(75) Inventor: Yi-Liang Chen, Taipei (TW)

(73) Assignee: PRIMAX ELECTRONICS LTD., Taipei (TW)

(21) Appl. No.: 13/015,417

(22) Filed: Jan. 27, 2011

(30) Foreign Application Priority Data
Nov. 26, 2010 (TW) 099140952

(51) Int. Cl. B65C 9/40; B65C 9/00

(52) U.S. Cl. 156/378; 156/767

(57) ABSTRACT

A label printing device includes a label printing mechanism, a peeling mechanism, and a scanning and verifying mechanism. The label printing mechanism is used for printing an image on a label sheet. The label sheet includes an adhesive paper part and a releasing paper part. The peeling mechanism is used for separating the adhesive paper part from the releasing paper part. The adhesive paper part printed with the image is transmitted to the scanning and verifying mechanism to be scanned. The scanning and verifying mechanism includes a scanning module for scanning the image, a first transmission unit and a third transmission unit. The first transmission unit includes plural plastic or metallic coaxial thin wheels, and the third transmission unit includes at least one thin star wheel, so that the contact areas between the first and third transmission units and the adhesive side of the adhesive paper part are reduced.

### CROSS-REFERENCES TO RELATED APPLICATIONS

This non-provisional application claims priority under 35 U.S.C. §119(a) to Patent Application No(s). 099140952 filed in Taiwan, R.O.C. on Nov. 26, 2010, the entire contents of which are hereby incorporated by reference.

### FIELD OF THE INVENTION

The present invention relates to a printing device, and more particularly to a label printing device.

### BACKGROUND OF THE INVENTION

Generally, label papers printed with bar codes or prices are adhered on commodities for labeling the commodities.

For example, a label printing device with a stripping mechanism is disclosed in U.S. Pat. No. 4,035,808. As shown in FIG. 1, the label printing device 10 comprises a print head 11, an ink ribbon 12, a separating rod 13, two rollers 14 and a take-up roller 15. The label printing device 10 is used for printing and stripping a paper tape 20. The paper tape 20 comprises a label paper 21 and a strippable cover web 22. The label paper 21 comprises an adhesive side and a non-adhesive side. The adhesive side is attached on the cover web 22. The non-adhesive side is a made of a plain-paper material and used for receiving the printed image. When the paper tape 20 is transported through the region between the print head 11 and the ink ribbon 12, an image is printed on the non-adhesive side of the label paper 21 by the print head 11. Then, the cover web 22 of the paper tape 20 is stripped by the separating rod 13, so that the label paper 21 is stayed at the outlet to be taken by the user. The cover web 22 is transported by the roller 14 of the label printing device 10, and thus recycled to the take-up roller 15

As known, the image printed on the label paper indicates the information associated with the commodity. If the image is erroneous, the consumers or the manufacturers fail to be apprehensive. For solving this drawback, a label printing device with a scanning and verifying mechanism has been disclosed. The scanning and verifying mechanism may assure that the image printed on the label is smoothly read and recognized by other electronic devices. For example, a bar code label printer with verifying and peeling functions is disclosed in U.S. Pat. No. 5,229,587.

FIG. 2 is a schematic view illustrating a conventional bar code label printer disclosed in U.S. Pat. No. 5,229,587. As shown in FIG. 2, the bar code label printer 30 comprises a roller 31, a printing unit 32, an ink ribbon 33, a bar code verifying unit 34, a peeling unit 35 and a drawing unit 36. The label sheet 40 comprises a paper web 41 and plural labels 42. The labels 42 are attached on the paper web 41 and arranged at regular intervals.

Please refer to FIG. 2 again. The label sheet 40 is fed into the printing unit 32 in the direction T by the roller 31. By a print head 321 and the ink ribbon 33, a bar code is printed on the label 42. The label 42 with the bar code is transported across a scanner 341 of the bar code verifying unit 34. The scanner 341 scans the image data of the bar code to verify the printing quality of the bar code. If the bar code is considered as an effective bar code, the paper web 41 and the label 42 are separated from each other by the peeling unit 35. Consequently, the peeled label 42 is transported in the direction C and discharged from the outlet to be taken by the user. Whereas, if the bar code is considered as an ineffective bar code, a semicircular shaft 351 of the peeling unit 35 is rotated to a second position. In this situation, the peeling function of the peeling unit 35 is disabled. Consequently, the peeled label 42 remains on the paper web 41. The peeled label 42 and the paper web 41 are fed to the drawing unit 36 in the direction B. In such way, the possibility of taking the ineffective bar code label 42 will be minimized.

Although the bar code label printer disclosed in U.S. Pat. No. 5,229,587 has both of the verifying function and the peeling function, there are still some drawbacks. For example, since the scanning and verifying mechanism is costly and it is not always necessary to read and recognize all of the labels by other electronic devices, most of the commercially available label printing devices are only equipped with the peeling mechanisms. If the user wants to utilize the function of verifying the image of the label, the costly label printing device needs to be purchased, or the label printing device may be equipped with an external scanning and verifying mechanism. Since the external scanning and verifying mechanism is usually arranged downstream of the peeling mechanism, during the label with an adhesive backside is transported and read by the external canning and verifying mechanism, the label printing device is readily suffered from a paper jam problem. The paper jam problem becomes hindrance from operating the label printing device and increases additional printing cost.

### SUMMARY OF THE INVENTION

The present invention provides a label printing device for minimizing the possibility of causing a paper jam problem.

In accordance with an aspect of the present invention, there is provided a label printing device. The label printing device includes a label printing mechanism, a peeling mechanism, and a scanning and verifying mechanism. The label printing mechanism is used for printing an image on a label sheet. The label sheet includes an adhesive paper part and a releasing paper part. The adhesive paper part includes an adhesive side and a non-adhesive side. The image is printed on the non-adhesive side of the adhesive paper part. The peeling mechanism is used for separating the adhesive paper part from the releasing paper part. The scanning and verifying mechanism is arranged beside the peeling mechanism for scanning the image printed on the adhesive paper part, and comparing the image with a predetermined image. The scanning and verifying mechanism includes a scanning module and a first transmission unit. The scanning module has a scanning surface to be contacted with the non-adhesive side of the adhesive paper part for reading the image. The first transmission unit is disposed under the scanning surface for transporting the adhesive paper part through the scanning module, wherein the first transmission unit comprises a shaft body and plural thin wheels, wherein the plural thin wheels are parallel with each other and sheathed around the shaft body, thereby reducing a contact area between the first transmission unit and the adhesive side of the adhesive paper part.

In an embodiment, the diameter of each of the plural thin wheels is greater than that of the shaft body.

In an embodiment, the plural thin wheels are ratchets.

In an embodiment, the plural thin wheels are toothed thin wheels.

In an embodiment, the scanning and verifying mechanism further includes a marking member, a second transmission unit and a third transmission unit. The marking member is arranged downstream of the first transmission unit. If the scanning and verifying mechanism judges that the image is different from the predetermined image, the marking member is enabled to produce a mark on the non-adhesive side of the adhesive paper part. The second transmission unit and the third transmission unit are disposed under the marking member for transporting the adhesive paper part to an outlet.

In an embodiment, the third transmission unit is contacted with the adhesive side of the adhesive paper part, and includes at least one thin wheel for reducing a contact area between the third transmission unit and the adhesive side of the adhesive paper part.

In an embodiment, the thin wheel is a ratchet.

In an embodiment, the thin wheel is a toothed thin wheel.

In an embodiment, the marking member includes a marking head and a solenoid valve. The marking head is used for producing a mark on the adhesive paper part. The solenoid valve is connected with the marking head for moving the marking head upwardly and downwardly with respect to the adhesive paper part.

In an embodiment, the marking head is a seal, a punching head or a trimming knife, and the mark is an unqualified symbol, an opening or a notch.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating a conventional label printing device disclosed in U.S. Pat. No. 4,035,808;

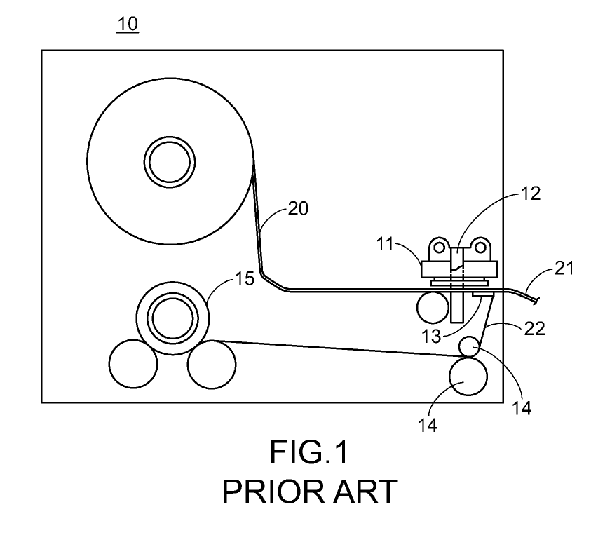

FIG. 2 is a schematic view illustrating a conventional bar code label printer disclosed in U.S. Pat. No. 5,229,587;

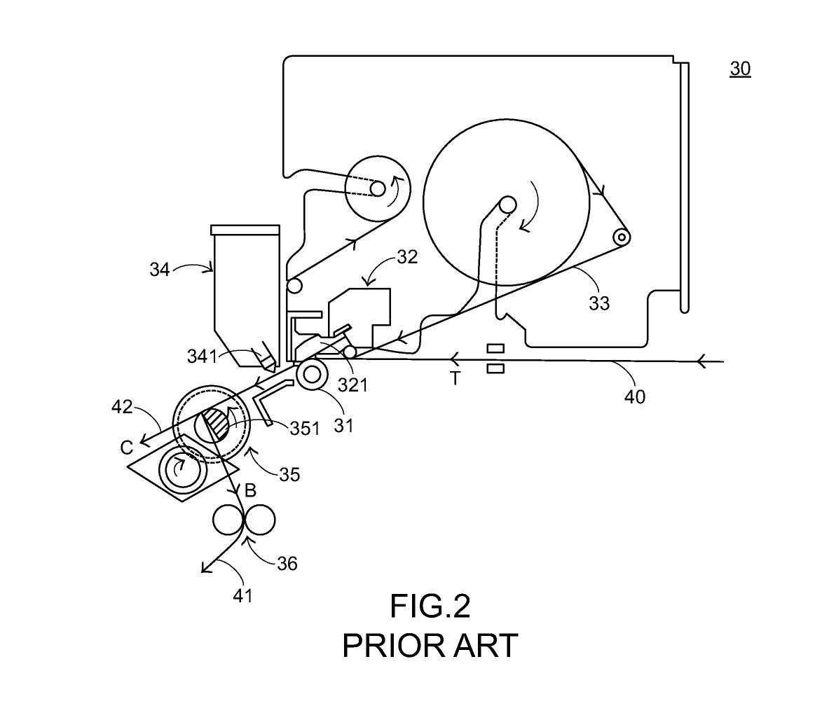

FIG. 3 is a schematic view illustrating a label printing device according to a first embodiment of the present invention;

FIG. 4 is a schematic perspective view illustrating the first transmission unit used in the label printing device of FIG. 3;

FIG. 5 is a schematic view illustrating a label printing device according to a second embodiment of the present invention; and

FIG. 6 is a schematic perspective view illustrating the third transmission unit used in the label printing device of FIG. 5.

### DETAILED DESCRIPTION OF THE PREFERRED EMBODIMENT

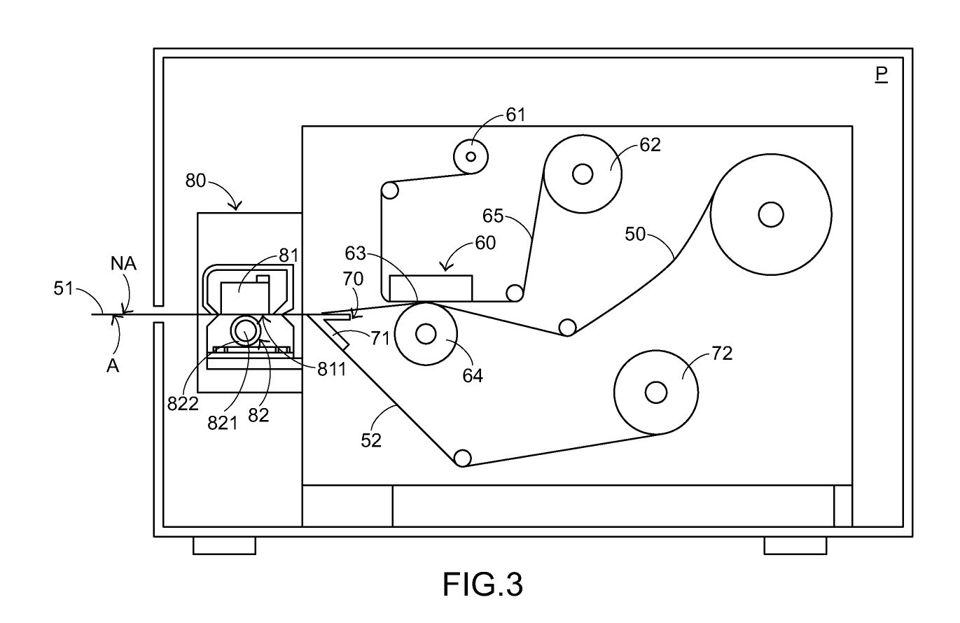

FIG. 3 is a schematic view illustrating a label printing device according to a first embodiment of the present invention. As shown in FIG. 3, the label printing device P comprises a label printing mechanism 60, a peeling mechanism 70, and a scanning and verifying mechanism 80. The label sheet 50 comprises an adhesive paper part 51 and a releasing paper part 52. The adhesive paper part 51 has an adhesive side A and a non-adhesive side NA. The adhesive side A is attached on the releasing paper part 52.

The label printing mechanism 60 comprises a ribbon supplying terminal 61, a ribbon recovering terminal 62, a thermal print head 63, a pressing roller 64 and an ink ribbon 65. Both ends of the ink ribbon 65 are respectively fixed on the ribbon supplying terminal 61 and the ribbon recovering terminal 62. The pressing roller 64 is disposed under the thermal print head 63 for transporting the label sheet 50 and the ink ribbon 65. When the label sheet 50 and the ink ribbon 65 are transported through the thermal print head 63, the heat provided by the thermal print head 63 will allow the coating of the ink ribbon 65 to be transferred to the adhesive paper part 51 of the label sheet 50, so that an image is printed on the non-adhesive side NA of the adhesive paper part 51. After the image printing operation is completed, the label sheet 50 with the printed image is transported to the peeling mechanism 70.

The peeling mechanism 70 comprises a peeling platform 71 and a take-up roller 72. By the peeling platform 71, the adhesive paper part 51 and the releasing paper part 52 of the label sheet 50 are separated from each other. The adhesive paper part 51 is continuously moved forwardly and fed into the scanning and verifying mechanism 80. Upon rotation of the take-up roller 72, the releasing paper part 52 is wound around the take-up roller 72 for facilitating the user to recover the releasing paper part 52.

Please refer to FIG. 3 again. The scanning and verifying mechanism 80 is arranged beside the peeling mechanism 70. The scanning and verifying mechanism 80 comprises a scanning module 81 and a first transmission unit 82. The scanning module 81 has a scanning surface 811. The first transmission unit 82 is disposed under the scanning module 81. When the adhesive paper part 51 is fed into the scanning and verifying mechanism 80, the first transmission unit 82 is contacted with the adhesive side A of the adhesive paper part 51 for transporting the adhesive paper part 51 through the scanning module 81. During the adhesive paper part 51 is transported through the scanning module 81, the non-adhesive side NA of the adhesive paper part 51 is contacted with the scanning surface 811 of the scanning module 81, so that the image printed on adhesive paper part 51 is read by the scanning module 81. By comparing the read image with a predetermined image which is stored in the scanning and verifying mechanism 80, the scanning module 81 can verify the printing quality of the image. In this embodiment, an example of the sensor used in the scanning and verifying mechanism 80 includes but is not limited to a contact image sensor (CIS).

However, in a case that the adhesive paper part 51 sticks on the first transmission unit 82, the label printing device P is readily suffered from a paper jam problem. For preventing from the paper jam problem, the first transmission unit 82 should be specially designed. In this embodiment, the first transmission unit 82 comprises a shaft body 821 and plural thin wheels 822. The uses of the thin wheels 822 may reduce the contact area between the first transmission unit 82 and the adhesive side A of the adhesive paper part 51.

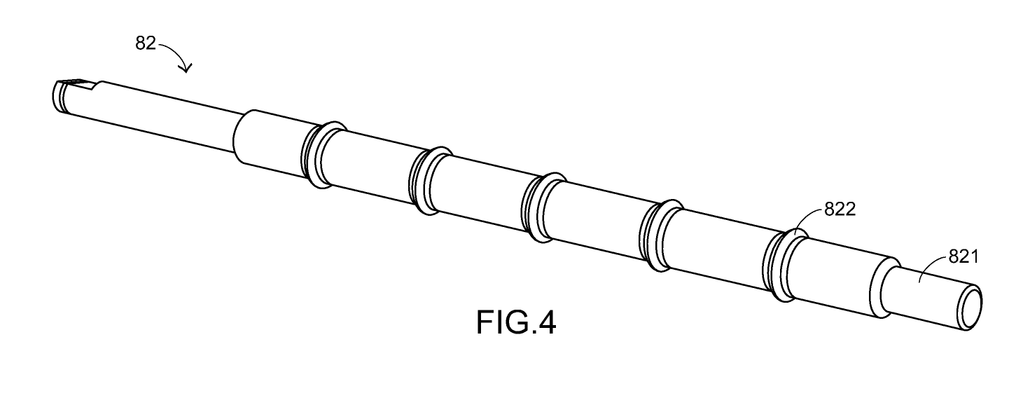

Hereinafter, the configurations of the first transmission unit 82 will be illustrated in more details with reference to FIG. 4. FIG. 4 is a schematic perspective view illustrating the first transmission unit used in the label printing device of FIG. 3. As shown in FIG. 4, the diameter of each of the plural thin wheels 822 is greater than the diameter of the shaft body 821. These thin wheels 822 are parallel with each other and sheathed around the shaft body 821. Consequently, the thin wheels 822 are synchronously rotated with the shaft body 821. In addition, the thin wheel 822 is a plastic thin wheel or a metallic thin wheel whose inner periphery is thicker than the outer periphery. Due to the thicker inner periphery, the thin wheel 822 can be firmly sheathed around the shaft body 821. In addition, since the thinner outer periphery of the thin wheel 822 is configured to be contacted with the adhesive paper part 51, the contact area between the thin wheel 822 and the adhesive side A of the adhesive paper part 51 will be reduced.

In this embodiment, the thicknesses of the inner periphery and the outer periphery of the thin wheel are different. It is noted that numerous modifications and alterations of the thin wheel may be made while retaining the teachings of the invention. For example, the mechanical element whose outer periphery has alternate concave and convex structures may be used as the thin wheel. For example, a ratchet or a toothed thin wheel may be used as the thin wheel of the present invention to reduce the contact area with the adhesive side A of the adhesive paper part 51.

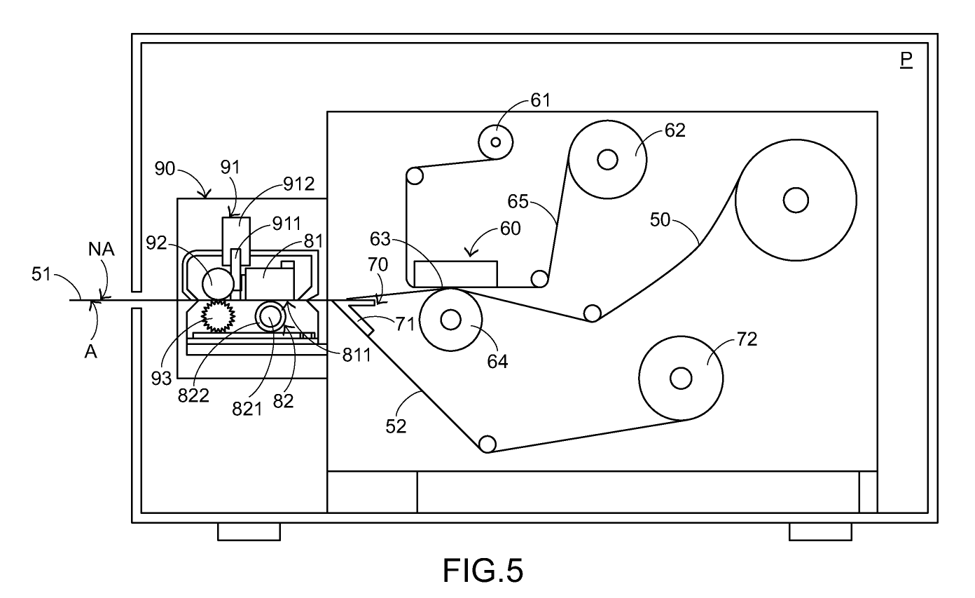

A second embodiment of the present invention will be illustrated with reference to FIG. 5. FIG. 5 is a schematic view illustrating a label printing device according to a second embodiment of the present invention. As shown in FIG. 5, the label printing device P comprises a label printing mechanism 60, a peeling mechanism 70, and a scanning and verifying mechanism 90. The scanning and verifying mechanism 90 is arranged beside the peeling mechanism 70. The scanning and verifying mechanism 90 comprises a scanning module 81, a first transmission unit 82, a marking member 91, a second transmission unit 92 and a third transmission unit 93.

The configurations of the second embodiment (see FIG. 5) are substantially identical to those of the first embodiment (see FIG. 3) except that the scanning and verifying mechanism 90 of the second embodiment further comprises the marking member 91, the second transmission unit 92 and the third transmission unit 93. The marking member 91 comprises a marking head 911 and a solenoid valve 912, which are arranged downstream of the first transmission unit 82. The solenoid valve 912 is connected with the marking head 911 for moving the marking head 911 upwardly and downwardly with respect to the adhesive paper part 51. The second transmission unit 92 and the third transmission unit 93 are arranged downstream of the second transmission unit 92 and a third transmission unit 93.

The first transmission unit 82 is disposed under the scanning module 81. When the adhesive paper part 51 is fed into the scanning and verifying mechanism 90, the first transmission unit 82 is contacted with the adhesive side A of the adhesive paper part 51 for transporting the adhesive paper part 51 through the scanning module 81. During the adhesive paper part 51 is transported through the scanning module 81, the non-adhesive side NA of the adhesive paper part 51 is contacted with the scanning surface 811 of the scanning module 81, so that the image printed on adhesive paper part 51 is read by the scanning module 81. By comparing the read image with a predetermined image which is stored in the scanning and verifying mechanism 90, the scanning module 81 can verify the printing quality of the image.

However, in a case that the adhesive paper part 51 sticks on the first transmission unit 82, the label printing device P is readily suffered from a paper jam problem. For preventing from the paper jam problem, the first transmission unit 82 should be specially designed. In this embodiment, the first transmission unit 82 comprises a shaft body 821 and plural thin wheels 822 (see also FIG. 4). The uses of the thin wheels 822 may reduce the contact area between the first transmission unit 82 and the adhesive side A of the adhesive paper part 51.

After the adhesive paper part 51 is verified, the adhesive paper part 51 is transported to the region under the marking member 91 by the first transmission unit 82. If the image printed on the adhesive paper part 51 matches the predetermined image stored in the scanning and verifying mechanism 90, the adhesive paper part 51 is directly transported to the outlet by the second transmission unit 92 and the third transmission unit 93, so that the adhesive paper part 51 can be taken by the user. On the other hand, if the mage printed on the adhesive paper part 51 does not match the predetermined image stored in the scanning and verifying mechanism 90, the solenoid valve 912 of the marking member 91 is enabled to drive the marking head 911 (e.g. a seal) to produce an unqualified symbol on the adhesive paper part 51. Then, the adhesive paper part 51 with the unqualified symbol is transported to the outlet by the second transmission unit 92 and the third transmission unit 93. The unqualified symbol may prompt the user that the printing quality of the image of the adhesive paper part 51 is unacceptable. In some embodiments, the marking head 911 is a punching head or a trimming knife for producing another symbol (e.g. an opening or a notch) to be recognized by the user.

Normally, the rotation of the second transmission unit 92 is driven by a power device (not shown) of the label printing device P, and thus the adhesive paper part 51 can be transported by the second transmission unit 92 to be departed from the scanning and verifying mechanism 90. However, in a case that the adhesive paper part 51 sticks on the third transmission unit 93, which is served as a driven roller, the label printing device P is readily suffered from a paper jam problem. For preventing from the paper jam problem, the third transmission unit 93 needs to be specially designed. For example, the third transmission unit 93 comprises at least one thin wheel such as a ratchet (e.g. a thin star wheel 931) for reducing the contact area between the third transmission unit 93 and the adhesive side A of the adhesive paper part 51. Hereinafter, the present invention will be illustrated by referring to a third transmission unit 93 with plural thin star wheels 931. It is noted that the number of the thin star wheels 931 may be varied according to the practical requirements.

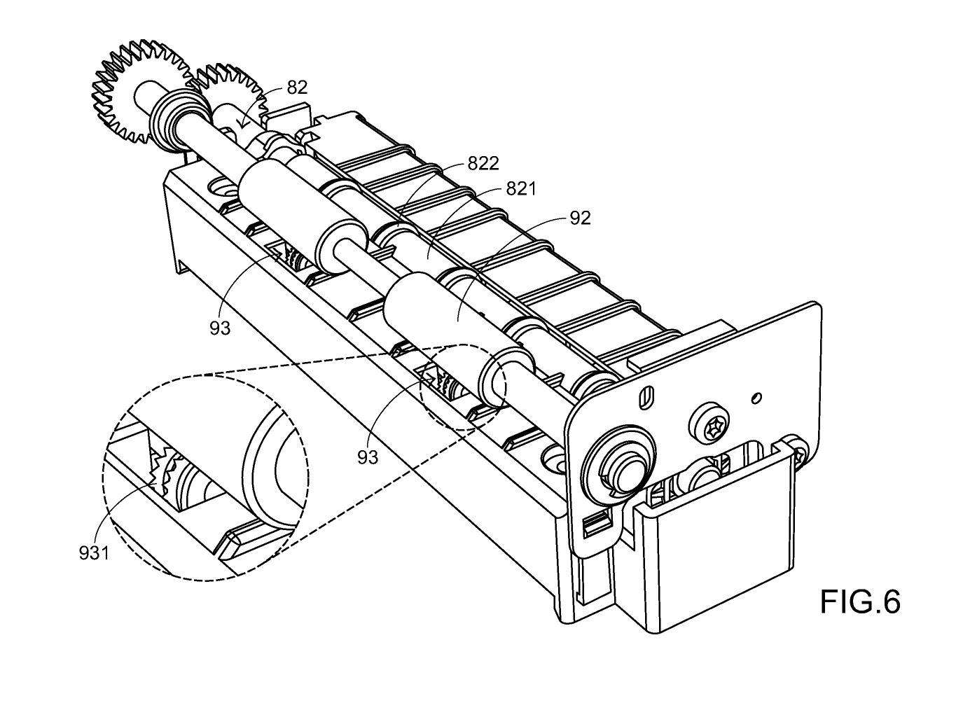

FIG. 6 is a schematic perspective view illustrating the third transmission unit used in the label printing device of FIG. 5. The thin star wheels 931 are installed on the bottom casing to be contacted with the adhesive side A of the adhesive paper part 51. Consequently, the thin star wheels 931 may assist the second transmission unit 92 in transporting the adhesive paper part 51 to the outlet. In this embodiment, the thin star wheels 931 are metallic thin star wheels for reducing the contact area between the third transmission unit 93 and the adhesive side A of the adhesive paper part 51. It is noted that numerous modifications and alterations of the thin wheel may be made while retaining the teachings of the invention. For example, any mechanical element (e.g. a toothed thin wheel) whose outer periphery has alternate concave and convex structures may be used as the thin wheel. Alternatively, the thicknesses of the inner periphery and the outer periphery of the thin wheel may be different. The profiles of the thin wheel are not restricted as long as the contact area with the adhesive side A of the adhesive paper part 51 is reduced.

From the above description, the label printing device of the present invention uses the peeling mechanism to peel the label sheet. The peeled adhesive paper part is transmitted to the scanning and verifying mechanism. In the scanning and verifying mechanism, the image on the adhesive paper part is scanned and compared with a predetermined image, or otherwise a mark is formed on the adhesive paper part. During the process of transporting the adhesive paper part, since the contact area between the thin wheel and the adhesive side of the adhesive paper part is reduced, the possibility of causing the paper jam problem in the label printing device will be minimized or eliminated. As a consequence, the label will be smoothly produced. In other words, since the complicated process and cost of changing an additional machine are omitted, the use of the label printing device of the present invention is more convenient, simplified and cost-effective.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A label printing device, comprising:
a label printing mechanism for printing an image on a label sheet, wherein said label sheet comprises an adhesive paper part and a releasing paper part, said adhesive paper part comprises an adhesive side and a non-adhesive side, and said image is printed on said non-adhesive side of said adhesive paper part;
a peeling mechanism for separating said adhesive paper part from said releasing paper part; and
a scanning and verifying mechanism arranged beside said peeling mechanism for scanning said image printed on said adhesive paper part, and comparing said image with a predetermined image, wherein said scanning and verifying mechanism comprises:
a scanning module having a scanning surface to be contacted with said non-adhesive side of said adhesive paper part for reading said image; and
a first transmission unit disposed under said scanning surface for transporting said adhesive paper part through said scanning module, wherein said first transmission unit comprises a shaft body and plural thin wheels, wherein said plural thin wheels are parallel with each other and sheathed around said shaft body, thereby reducing a contact area between said first transmission unit and said adhesive side of said adhesive paper part.

2. The label printing device according to claim 1 wherein the diameter of each of said plural thin wheels is greater than that of said shaft body.

3. The label printing device according to claim 1 wherein said plural thin wheels are ratchets.

4. The label printing device according to claim 1 wherein said plural thin wheels are toothed thin wheels.

5. The label printing device according to claim 1 wherein said scanning and verifying mechanism further comprises:
a marking member arranged downstream of the first transmission unit, wherein if said scanning and verifying mechanism judges that said image is different from said predetermined image, said marking member is enabled to produce a mark on said non-adhesive side of said adhesive paper part; and
a second transmission unit and a third transmission unit disposed under said marking member for transporting said adhesive paper part to an outlet.

6. The label printing device according to claim 5 wherein said third transmission unit is contacted with said adhesive side of said adhesive paper part, and comprises at least one thin wheel for reducing a contact area between said third transmission unit and said adhesive side of said adhesive paper part.

7. The label printing device according to claim 6 wherein said thin wheel is a ratchet.

8. The label printing device according to claim 6 wherein said thin wheel is a toothed thin wheel.

9. The label printing device according to claim 5 wherein said marking member comprises:
a marking head for producing a mark on said adhesive paper part; and
a solenoid valve connected with said marking head for moving said marking head upwardly and downwardly with respect to said adhesive paper part.

10. The label printing device according to claim 9 wherein said marking head is a seal, a punching head or a trimming knife, and said mark is an unqualified symbol, an opening or a notch.
